(19) United States
(12) Patent Application Publication
(10) Pub. No.: US 2025/0026422 A1
(43) Pub. Date: Jan. 23, 2025

(54) Locking Device for a Driveshaft of a Bicycle, and Bicycle Comprising Same

(71) Applicant: ZF Friedrichshafen AG, Friedrichshafen (DE)

(72) Inventor: Peter Ziemer, Bad Woerishofen (DE)

(21) Appl. No.: 18/714,609

(22) PCT Filed: Nov. 28, 2022
(86) PCT No.: PCT/EP2022/083452

§ 371 Date: May 30, 2024

(30) Foreign Application Priority Data
Nov. 30, 2021 (DE) 10 2021 213 516.1

(51) Int. Cl. B62H 5/10

(52) U.S. Cl. CPC B62H 5/10

(57) ABSTRACT

A locking device (1) for a drive shaft (2) of a bicycle includes a radially outwardly extending, disk-shaped portion (3) non-rotatably mountable on the drive shaft (2). The radially outwardly extending, disk-shaped portion (3) has at least one groove (5) in a radially outer edge region (4). The locking device (1) also includes a locking element (6) arranged adjacently to the radially outer edge region (4) and an actuatable shift element (7) mechanically operatively connected to the locking element (6). The shift element (7) is actuatable to bring the locking element (6) into interlocking connection with the at least one groove (5) in order to lock the drive shaft (2).

### CROSS-REFERENCE TO RELATED APPLICATIONS

The present application is related and has right of priority to German Patent Application No. DE102021213516.1 filed on Nov. 30, 2021 and is a U.S. National Phase of PCT/EP2022/083452 filed on Nov. 28, 2022, both of which are incorporated by reference in their entirety for all purposes.

### TECHNICAL FIELD

The present invention relates generally to a locking device for a drive shaft of a bicycle. The invention also relates generally to a bicycle having the locking device.

### BACKGROUND

Immobilizers for motor vehicles, in particular for electrically propelled motor vehicles, are known. In this connection, a drive axle of the motor vehicle is mechanically or electrically blocked when the prime mover is switched off. This function is not yet known for bicycles.

### BRIEF SUMMARY

A first example aspect of the invention relates to a locking device for a drive shaft of a bicycle. The drive shaft can be mechanically operatively connected to a propulsion device and to a crank axle of the bicycle. For example, the drive shaft can be in the form of a crank axle which is mounted in a housing by bearings. For example, the drive shaft can be mechanically operatively connected to a rotary element of a transmission of the propulsion device. By the drive shaft, a propulsion force applied onto the crank axle in the form of a torque can be transmitted to the propulsion device of the bicycle and amplified by the propulsion device. This force transmission via the drive shaft can be interrupted by the locking device. For example, the locking device can block a rotational motion of the drive shaft, such that torque for propelling the bicycle cannot be transmitted by the drive shaft. The bicycle can be an electric bicycle, in particular a hybrid powered pedelec. In a pedelec, a propulsion force of the bicycle generated by muscle power can be combined with an electrically generated propulsion force of the bicycle.

The locking device has a radially outwardly extending, disk-shaped portion, which is non-rotatably mountable on the drive shaft. The disk-shaped portion can extend outwardly from the longitudinal axis, or the rotational axis, of the drive shaft in a radial direction relative to a longitudinal axis, or a rotational axis, of the drive shaft. The radially outwardly extending, disk-shaped portion can extend primarily in a radial direction. A length of extension of the disk-shaped portion along the axial direction relative to the longitudinal axis of the drive shaft can be short as compared to the length of extension in a radial direction. Accordingly, the outwardly extending portion can be in the form of a disk extending in a radial direction. The disk-shaped portion can be made of an inelastic material, for example, aluminum or steel. Alternatively, the disk-shaped portion can be made of a non-metallic material, for example, a plastic or carbon. The radially outwardly extending, disk-shaped portion can be, for example, bolted to the drive shaft or interlockingly connected thereto in another manner, for example, by an abutment. The disk-shaped portion can be prevented from rotating relative to the drive shaft since the disk-shaped portion is non-rotatably mounted on the drive shaft. Therefore, a rotational motion of the drive shaft can be blocked by arresting the disk-shaped portion.

The radially outwardly extending, disk-shaped portion has at least one groove in a radially outer edge region. The radially outer edge region of the disk-shaped portion can be the region of the disk-shaped portion that is farthest away from the drive shaft in a radial direction relative to the longitudinal axis of the drive shaft. Accordingly, the radially outer edge region can include the outer circumference of the disk-shaped portion. The at least one groove can be present in the form of a recess or in the form of a space in the edge region that is not filled with material. The shape of the at least one groove can correspond to the shape of a counterpiece to be brought into connection with the groove. Alternatively or additionally, a space can be provided between the groove and the counterpiece to be brought into connection with the groove, in order, for example, to compensate for manufacturing tolerances.

The locking device also has a locking element, which is arranged adjacently to the radially outer edge region. The locking element and the edge region can be in contact with one another at least in sections and at least temporarily. Alternatively or additionally, the locking element can be spaced apart from the edge region, such that there is distance between the locking element and the edge region. By the locking element, the locking device can lock the drive shaft of the bicycle. For this purpose, the locking element can include, for example, clamping rollers, clamping elements, locking pawls, dog rings and/or wrap springs. Other types of locking elements are also conceivable.

Furthermore, the locking device has an actuatable shift element, which is mechanically operatively connected to the locking element. The shift element can be operatively connected to the locking element such that actuating the shift element brings about a mechanical connection between the shift element and the locking element. For example, the shift element can be brought into engagement with the locking element. Via this connection, the locking element can be actuated. For example, the locking element can be displaced via this connection from a free-wheeling position of the drive shaft into a locked position of the drive shaft. The shift element can be, for example, electronically actuated by a control signal. Alternatively or additionally, the shift element can be mechanically actuated, for example, by at least one Bowden cable.

The shift element is actuatable in order to bring the locking element into interlocking connection with the at least one groove in order to lock the drive shaft. The locking element can be brought into interlocking connection with the at least one groove, for example, by the mechanically operative connection between the locking element and the shift element. In order to interlockingly connect the locking element to the at least one groove, at least some sections of the locking element can have a shape which is opposite that of an inner circumference of the at least one groove. For example, at least some sections of the locking element can be rectangular in order to be able to be brought into interlocking connection with a rectangular groove. Alternatively, at least some sections of the locking element can be cylindrical in order to be interlockingly connected to the at least one groove, which has a cylindrical inner circumference. Further example embodiments of the locking element and of the at least one groove for establishing an interlocking connection are also conceivable. By the interlocking connection of the locking element and of the at least one groove, a rotational motion of the drive shaft, for example, for transmitting a torque, can be at least temporarily blocked. It can therefore be provided that, when the locking element and the at least one groove are interlockingly connected, the drive shaft can no longer be rotated.

Thus, according to the locking device according to example aspects of the invention, the drive shaft of the bicycle can be actuatably locked. The drive shaft and elements connected thereto, such as, for example, the pedal crank of the bicycle, can therefore be blocked from rotating. Therefore, a parking lock for the bicycle can be implemented when the bicycle is not being used, or is stopped. Due to the capability of the shift element to be actuated, the drive shaft can also be locked while the bicycle is being used, for example, during longer waits at a traffic light. As a result, using the locking device, the bicycle can be prevented from rolling backwards.

According to one example embodiment of the locking device, the at least one groove can be in the form of a recess in at least some sections of an outer circumference of the disk-shaped portion. The disk-shaped portion can have an outer circumference which extends, for example, in the shape of a curve, in particular, of a circle. It can be provided that the curved profile of the outer circumference is interrupted only in the region of the groove. In the region of the groove, the outer circumference of the disk-shaped portion can have a radially inwardly directed, for example, rectangular, recess. The formation of the groove in an outer circumference of the disk-shaped portion allows the groove to be open towards the outside in a radial direction of the drive shaft. Therefore, the locking element, which is arranged adjacently to the outer circumference of the disk-shaped portion, can be brought into connection directly with the groove. The construction of the locking device is simplified as a result.

According to a further example embodiment of the locking device, the at least one groove can be formed in the disk-shaped portion at a predefined circumferential position relative to a pedal crank, which is mountable on the drive shaft. The pedal crank can be connected, for example, to a pedal for propelling the bicycle. The pedal crank can be mountable on the drive shaft at a predetermined position, or orientation, for example, due to an intended mounting direction of the pedal crank. The at least one groove can be formed in the outer circumference of the disk-shaped portion relative to this predetermined position of the pedal crank. Due to the formation of the at least one groove at a predefined circumferential position relative to the pedal crank, the drive shaft can be locked in a predetermined position relative to the pedal crank by the locking element, which is connected to the groove.

According to a further example embodiment of the locking device, the disk-shaped portion can have at least one further groove in the radially outer edge region, the further groove being offset relative to the at least one groove in a circumferential direction. The circumferential direction can refer, in this case, to the direction of a profile of the outer circumference of the disk-shaped portion. The at least one further groove can be spaced apart from the at least one groove in this direction. The at least one further groove can have a shape that is equivalent to that of the at least one groove. For example, the at least one further groove can be open towards the outside in a radial direction. In addition, the at least one further groove can have an inner contour, the shape of which is opposite that of an outer contour of the locking element. Alternatively, the at least one further groove can be designed differently from the at least one groove. Providing one further groove in the disk-shaped portion offers the advantage that the drive shaft can be locked in at least two positions by the locking element.

In this example embodiment, the at least one further groove can be offset relative to the at least one groove by 180° in a circumferential direction of the disk-shaped portion. Thus, the at least one further groove can be offset from the at least one groove by one-half of a total length of the outer circumference of the disk-shaped portion. The at least one further groove can therefore be arranged on the disk-shaped portion opposite the at least one groove. This example embodiment offers the advantage that the drive shaft can be locked in two predefined positions which are radially mirrored relative to the drive shaft. In particular, when the two grooves are arranged relative to a pedal crank, which is mountable on the drive shaft, the pedal crank can therefore be fixed in two radially mirrored positions in this example embodiment. For example, the pedal crank in this example embodiment can be fixed by the locking device in a position oriented perpendicularly to a running surface of the bicycle. The pedal crank can be fixed perpendicularly upward relative to the running surface of the bicycle and perpendicularly downward relative to the running surface of the bicycle. Due to this perpendicular orientation of the pedal crank, a torque which can be applied onto the fixed pedal crank and a force acting on the pedal crank due to this torque can be minimized. Therefore, the risk of intentional damage to the propulsion device can be reduced.

According to a further example embodiment, the locking element can include a rotatably mounted locking pawl, which can be brought into engagement with the at least one groove by the shift element. A locking pawl can be understood to mean a locking element, at least one end portion of which can be brought into engagement with a component to be locked. A locking pawl can lock the component to be locked, for example, in a first direction of rotation and, in a second direction of rotation, allow the component to freewheel. Alternatively, the locking pawl can lock the component to be locked in both directions of rotation, i.e., in a direction-independent manner. For example, the drive shaft can be mounted in a bottom bracket of the bicycle. In this case, the locking pawl can be rotatably mounted in the region of the bottom bracket of the bicycle, for example, adjacently to an outer circumference of the bottom bracket. The locking pawl can be mounted so as to be rotatable relative to an axis of rotation extending axially parallel to the drive shaft. For example, the locking pawl can be rotatably mounted relative to the axis of rotation by a pivot bearing. The locking pawl can at least partially absorb a force which is generated by a torque of the drive shaft and acts on the disk-shaped portion. This force can be transmitted, for example, to a frame of the bicycle via the locking pawl. By a rotatably mounted locking pawl, the drive shaft can be particularly easily locked using only a few components.

In this example embodiment, the locking element can have a spring element, which preloads the locking pawl towards the disk-shaped portion. The spring element can be in the form, for example, of a compression spring, which is arranged outside the locking pawl in a radial direction relative to the drive shaft. The radially outward compression spring can be at least partially compressed and can be connected to the locking pawl. Therefore, the compression spring can exert a compressive force onto the locking pawl in order to press the locking pawl radially inward, i.e., towards the disk-shaped portion. Alternatively, the spring element can be in the form, for example, of a tension spring, which is arranged radially inside the locking pawl relative to the drive shaft and is connected to the locking pawl. In this case, the tension spring can exert a pulling force onto the locking pawl in order to pull the locking pawl radially inward. Other types of spring elements for preloading the locking pawl towards the disk-shaped portion are also conceivable. By the spring element, the locking pawl can be preloaded towards the radially outer edge region of the disk-shaped portion. As a result, the locking pawl can be easily brought into connection with the at least one groove.

According to one example embodiment, the actuatable shift element can be in the form of a rotatably mounted shift drum, the outer circumference of which can be brought into contact with the locking element. The shift drum can be in the form of a shaft, which is rotatable relative to an axis of rotation extending axially parallel to the drive shaft. For example, the shift drum can be rotatably accommodated in a projection on the housing of a propulsion device of the bicycle. The shift drum can be arranged adjacently to a bottom bracket of the bicycle. The shift drum can be used, for example, to initiate a gear shift in a transmission of the bicycle. The outer circumference of the shift drum can be in permanent contact with the locking element. Alternatively, the outer circumference of the shift drum can be in contact with the locking element only temporarily, for example, in order to carry out a locking operation. The locking element can be easily actuated by rotating the rotatable shift drum.

In this example embodiment, at least some sections of the outer circumference of the shift drum can have a curved path, by which the locking element can be actuated upon rotation of the shift drum. The curved path can be present, for example, in the form of a radially inwardly directed recess in the outer circumference of the shift drum. Alternatively or additionally, the curved path can be present, for example, in the form of a radially outwardly directed projection on the outer circumference of the shift drum. The locking element can slide, for example, on the outer circumference of the shift drum upon rotation thereof. If the locking element slides along the curved path, a position, or orientation, of the locking element can be changed as a result. Due to the change in position, or orientation, of the locking element, the locking element can be actuated. At least some sections of the outer circumference of the shift drum can have further curved paths, which can be used, for example, to initiate a gear shift in a transmission of the bicycle.

In this example embodiment, by the at least one curved path of the outer circumference of the shift drum, the locking element can be brought into interlocking connection with the at least one groove. For example, the shift drum can be actuated in order to rotate. Due to this rotation of the shift drum, the interlocking connection of the locking element with the at least one groove can be established. The drive shaft can be locked by this interlocking connection. Thus, the drive shaft of the bicycle can be locked by actuating the shift drum. As a result, a parking lock of the bicycle can be implemented in a particularly simple manner.

A second example aspect of the invention relates to a bicycle, which includes a propulsion device and the locking device according to the first example aspect, wherein the disk-shaped portion is non-rotatably mountable on a drive shaft of the propulsion device. By the locking device according to the first example aspect, the drive shaft of the propulsion device can be locked. Respective further features, example embodiments and advantages are found in the descriptions of the first example aspect. Conversely, features, embodiments and advantages of the second example aspect are also features, embodiments and advantages of the first example aspect.

### BRIEF DESCRIPTION OF THE DRAWINGS

FIG. 1 schematically shows a locking device according to one example embodiment of the invention arranged in a bottom bracket of a bicycle.

FIG. 2 schematically shows the locking device according to the example embodiment from FIG. 1 in a locked state.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

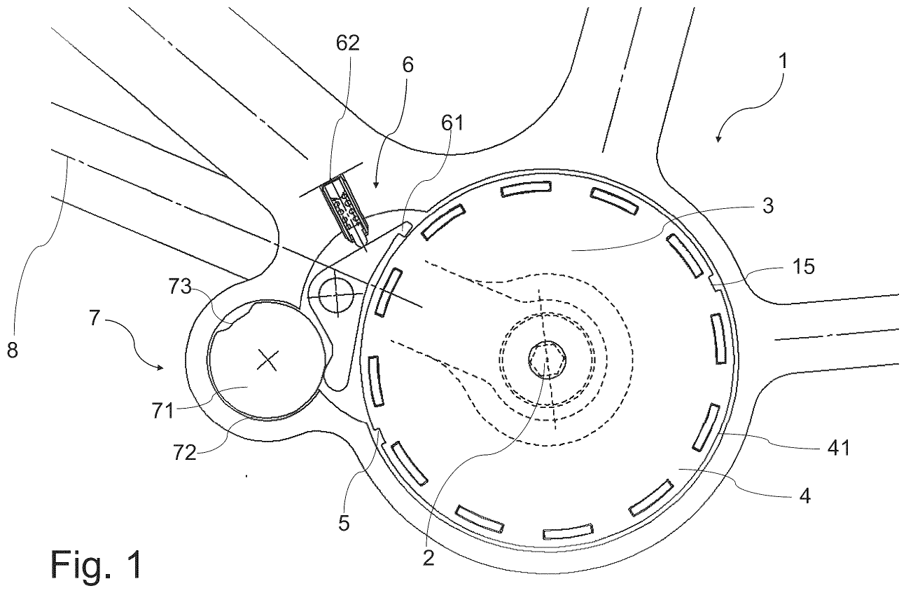

FIG. 1 schematically shows a locking device 1 arranged in a bottom bracket of a bicycle, which is not shown in FIG. 1. By the locking device 1, a drive shaft 2 of the bicycle can be locked. For this purpose, the locking device 1 has a radially outwardly extending, disk-shaped portion 3, which is non-rotatably mountable on the drive shaft 2. The disk-shaped portion 3 has at least one groove 5 in a radially outer edge region 4. In the embodiment from FIG. 1, the at least one groove 5 is shown in the form of a rectangular recess in an outer circumference 41 of the radially outer edge region 4 of the disk-shaped portion 3.

A locking element 6 is arranged adjacently to the radially outer edge region 4 of the disk-shaped portion 3. In the schematic view from FIG. 1, the locking element 6 is arranged on a frame of the bicycle adjacently to the bottom bracket. The locking element 6 has a locking pawl 61, which is rotatably mounted on the frame. In addition, the locking element 6 has a spring element 62, which is in the form of a compression spring 62 in the schematic view from FIG. 1. The compression spring 62 preloads the locking pawl 61 towards the disk-shaped portion 3.

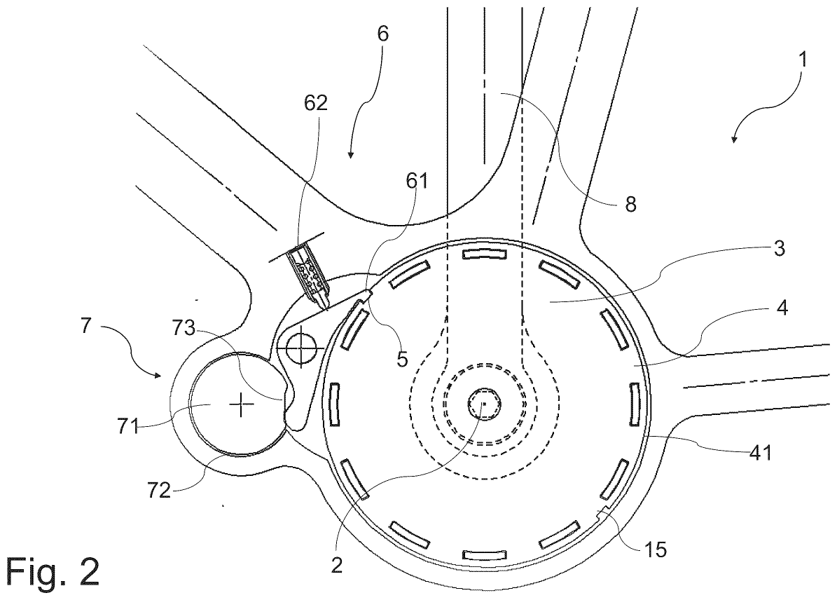

In a projection on the bicycle frame, an actuatable shift element 7 is arranged adjacently to the locking element 6. The shift element 7 is mechanically operatively connected to the locking element 6. Specifically, by the shift element 7, the rotatably mounted locking pawl 6 can be brought into engagement with the at least one groove 5. The shift element 7 is shown in FIG. 1 in the form of a shift drum 71, which is rotatably mounted in the projection on the bicycle frame. In the example embodiment from FIG. 1, the shift drum 71 can be brought into contact via the outer circumference 72 of the shift drum 71 with the locking element 6. Specifically, a projection on the locking pawl 61 can slide on the outer circumference 72 of the shift drum 71 when the shift drum 71 rotates. At least some sections of the outer circumference 72 of the shift drum 71 have a curved path 73, by which the locking element 6 can be actuated upon rotation of the shift drum 71. The actuation of the locking element 6 by the curved path 73 of the shift drum 71 is described in greater detail in the explanation of FIG. 2.

According to the example embodiment from FIG. 1, at least one further groove 15 is formed in the radially outer edge region 4 of the disk-shaped portion 3. The at least one further groove 15 is offset relative to the at least one groove 5 by 180° in a circumferential direction of the disk-shaped portion 3. In the schematic view from FIG. 1, a pedal crank 8 for propelling the bicycle by muscle power is mounted on the drive shaft 2. The at least one groove 5 and the at least one further groove 15 are each formed at a predefined circumferential position on the outer circumference 41 of the disk-shaped portion 4 relative to the pedal crank 8.

FIG. 2 schematically shows the locking device 1 according to the example embodiment from FIG. 1 in a locked state of the drive shaft 2. Here, the shift drum 71 has been actuated in order to rotate about the axis of rotation. During this rotational motion of the shift drum 71, the projection on the locking pawl 61 slides along the outer circumference 72 of the shift drum 71. If the projection on the locking pawl 61 slides along the curved path 73 formed in the outer circumference 72 of the shift drum 71, the locking element 6 is actuated such that the locking pawl 61 is brought into engagement with the at least one groove 5.

In the locked state shown in FIG. 2, the locking pawl 61 of the locking element 6 is in interlocking connection with the groove 5 formed in the disk-shaped portion 3. Due to this interlocking connection, a rotational motion of the disk-shaped portion 3 relative to the drive shaft 2 is blocked. Due to the non-rotatable mounting of the disk-shaped portion 3 on the drive shaft 2, a rotational motion of the drive shaft 2 about an axis of rotation thereof is also blocked. Thus, the drive shaft 2 is locked due to the interlocking connection of the locking pawl 61 with the at least one groove 5.

As is apparent from the schematic view from FIG. 2, the at least one groove 5 is formed at a predefined circumferential position on the outer circumference 41 of the disk-shaped portion 3 relative to the pedal crank 8. Due to this predefined circumferential position of the at least one groove 5, the pedal crank 8 is oriented perpendicularly upward relative to a running surface of the bicycle. Thus, the torque that can be applied onto the pedal crank 8 is minimal when the drive shaft 2 is locked. The risk of damage to the propulsion device in the locked state, for example, due to intentional, excessively forceful pedaling on the pedal crank 8, can be reduced as a result.

A locked state of the drive shaft 2 is also achieved when the locking pawl 61 enters into engagement with the further groove 15, which is arranged along the outer circumference 41 of the disk-shaped portion 3 so as to be offset relative to the at least one groove 5 by 180°. In this case, the pedal crank 8 is oriented perpendicularly downward relative to the running surface of the bicycle. The above-described effect of a minimal torque that can be applied onto the pedal crank 8 occurs here as well.

In an example embodiment which is not shown, the active principle of the locking element and of the shift element is reversed. In this case, a locking element is initially not engaged with at least one groove. The engagement of the locking element with the at least one groove can be established by an actuatable shift element. Similarly, the drive shaft can be locked as a result.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 locking device
2 drive shaft
3 disk-shaped portion
4 edge region of the disk-shaped portion
41 outer circumference of the disk-shaped portion
5 groove
15 further groove
6 locking element
61 locking pawl
62 spring element, compression spring
7 shift element
71 shift drum
72 outer contour
73 curved path
8 pedal crank

1-11. (canceled)

12. A locking device (1) for a drive shaft (2) of a bicycle, comprising:
a radially outwardly extending, disk-shaped portion (3) non-rotatably mountable on the drive shaft (2), the radially outwardly extending, disk-shaped portion (3) having a groove (5) in a radially outer edge region (4);
a locking element (6) arranged adjacently the radially outer edge region (4); and
an actuatable shift element (7) mechanically operatively connected to the locking element (6),
wherein the shift element (7) is actuatable to bring the locking element (6) into interlocking connection with the groove (5) in order to lock the drive shaft (2).

13. The locking device (1) of claim 12, wherein the groove (5) comprises a recess in a section of an outer circumference (41) of the disk-shaped portion (3).

14. The locking device (1) of claim 12, wherein the groove (5) is formed in the disk-shaped portion (3) at a predefined circumferential position relative to a pedal crank (8) mountable on the drive shaft (2).

15. The locking device (1) of claim 12, wherein the disk-shaped portion (3) has a further groove (15) in the radially outer edge region (4), the further groove (15) offset relative to the groove (5) in a circumferential direction.

16. The locking device (1) of claim 15, wherein the further groove (15) is offset relative to the groove (5) by 180° in the circumferential direction on the disk-shaped portion (3).

17. The locking device (1) of claim 12, wherein the locking element (6) comprises a rotatably mounted locking pawl (61) engageable with the groove (5) by the shift element (7).

18. The locking device (1) of claim 17, wherein the locking element (6) comprises a spring element (62) that preloads the locking pawl (61) towards the disk-shaped portion (3).

19. The locking device (1) of claim 12, wherein the shift element (7) comprises a rotatably mounted shift drum (71) contactable with the locking element (6) via an outer circumference (72) of the shift drum (71).

20. The locking device (1) of claim 19, wherein at least some sections of the outer circumference (72) of the shift drum (71) comprise a curved path (73), by which the locking element (6) is actuatable upon rotation of the shift drum (71).

21. The locking device (1) of claim 20, wherein the locking element (6) is configured for interlocking connection with the groove (5) by the at least one curved path (73) of the outer circumference (72) of the shift drum (71).

22. A bicycle, comprising:
a propulsion device; and
the locking device (1) of claim 12,
wherein the disk-shaped portion (3) is non-rotatably mountable on a drive shaft (2) of the propulsion device, and the drive shaft (2) of the propulsion device is lockable by the locking device (1).
